(19) United States
(12) Patent Application Publication
(10) Pub. No.: US 2016/0262405 A1
(43) Pub. Date: Sep. 15, 2016

(54) System for Shaping and Conveying Food Products Made of Pasty Material

(71) Applicant: VEMAG Maschinenbau GmbH, Verden/Aller (DE)

(72) Inventors: Niclas Rathmann, Verden/Aller (DE); Christopher Hollmann, Achim (DE); Uwe Flammann, Kirchlinteln (DE)

(21) Appl. No.: 15/064,028

(22) Filed: Mar. 8, 2016

(30) Foreign Application Priority Data
Mar. 9, 2015 (DE) 10 2015 103 423.9

(51) Int. Cl. A21C 3/10; A21C 9/08

(52) U.S. Cl. CPC A21C 3/10; A21C 9/08

(57) ABSTRACT

A conveyor machine for conveying foodstuff products made of pasty material includes a machine frame and a conveyor device arranged on the machine frame for conveying the foodstuff products. In the conveyor machine described herein, the portioning unit has a portioning knife which in the working position of the portioning unit passes the conveyor path of the endless string at predetermined time intervals. The portioning knife is rotatably carried by way of a rotary bearing, wherein the portioning knife can be a single-blade or a multi-blade knife.

### CROSS REFERENCE TO RELATED APPLICATION

This application claims the priority of German Patent Application No. 10 2015 103 423.9, filed on Mar. 9, 2015 (pending), the disclosure of which is incorporated by reference herein in its entirety.

### TECHNICAL FIELD

The invention concerns a conveyor machine for conveying foodstuff products of pasty material, comprising a machine frame and a conveyor device arranged on the machine frame for conveying the foodstuff products. The invention further also relates to a system for shaping and conveying foodstuff products of pasty material.

### BACKGROUND

Such known conveyor machines or systems for shaping and conveying foodstuff products are used for the production of foodstuff products consisting of pasty foodstuff materials. A multiplicity of variable products of the same size and shape are respectively produced from the pasty materials like for example sausage meat or dough over a predetermined period of time. The products manufactured like for example meatballs, ground meat patties or portions of lengths of ground meat are delivered immediately after production by the shaping device, by means of a conveyor device for further subsequent processing or for direct packaging thereof.

The known systems for shaping and conveying foodstuff products have a shaping device for shaping the three-dimensional products to be produced consisting of the foodstuff material, wherein a product of predetermined shape and size can be produced by means of the shaping device. In addition connected downstream of the shaping device is a conveyor device for conveying foodstuff products like for example a conveyor belt. The foodstuff products produced are frequently directly taken over by the conveyor device which is associated with the delivery or discharge region of the shaping device. The conveyor device like for example a circulating conveyor belt transports the products to subsequently arranged devices for further processing thereof or to a packaging station.

The known systems usually constitute a unit which is a component part of an apparatus for processing foodstuffs. As a consequence of a product change which is to be implemented, changing from for example previously produced ball-shaped products to portions of lengths of ground meat, the system with the shaping and conveyor devices is removed in each case from the production line of a processing apparatus, as a complete unit. The removed system is then replaced by a different system with which the portions of lengths of ground meat are produced. The change at the production line is usually effected in the form of replacement of the entire system, for which reason replacement of the conveyor device is performed upon each change. In addition, such systems with their shaping and conveyor devices are of relatively large dimensions by virtue of the fact that they are in the form of a respective interconnected unit. That means that removal from the production line is sometimes highly complicated and time-consuming. The shaping and conveyor devices that are not required also have to be put into intermediate storage at suitable locations until the next use thereof.

Therefore the object of the invention is to provide a conveyor machine for conveying foodstuff products and a system for shaping and conveying foodstuff products of pasty material, with which the product change is simplified.

### SUMMARY

The invention attains its object by a conveyor machine described as follows.

The conveyor machine according to the invention has a portioning unit arranged on the machine frame of the conveyor machine, for subdividing an endless string shaped by a shaping module into string portions of predetermined length. By means of the portioning unit arranged on the conveyor machine, in particular the machine frame thereof, an endless string of pasty foodstuff material which is produced by a shaping module which can be respectively coupled to the conveyor machine can be subdivided into string portions of predetermined length.

In the conveyor machine according to the invention, the portioning unit has a portioning knife which in the working position of the portioning unit passes the conveyor path of the endless string at predetermined time intervals. The use of a portioning knife permits easy subdivision of an endless string respectively shaped with a shaping module and for example discharged therefrom into string portions of predetermined length. The portioning knife is rotatably carried by way of a rotary bearing, wherein the portioning knife can be a single-blade or a multi-blade knife. The axis of rotation of the rotary bearing preferably extends parallel to the conveyor direction of the endless string formed. The portioning knife is adapted to produce disk pieces of a substantially uniform circular cross-section, also referred to as a patty, or ground meat portions. Unless the positioning is not required, this can be converted into a stationary position on the conveying machine by pivoting or shifting.

The portioning unit is preferably adapted to be arranged for example at a spacing downstream of an outlet of a shaping module. In an alternative configuration the portioning unit is arranged in the conveyor direction of the pasty material upstream in relation to the outlet of a conveyor passage, wherein the portioning unit is guided through a slot arranged in front of the outlet in the conveyor passage and subdivides the string of pasty material into individual string portions while still in the conveyor passage.

Coupling means for releasably connecting the machine to at least one shaping module for the production of shaped foodstuff products are provided at the conveyor machine.

By virtue of the provision of a releasable connection between the conveyor machine and the shaping module used for the manufacture of shaped foodstuff products, it is possible to provide for a separation between the conveyor machine and the shaping module. That gives on the one hand the advantage that the product change at the production line is simplified as it is only necessary in the production line to change the region which is used directly for producing the various foodstuff products to be produced. On the other hand, the costs of manufacture of such a production line for different shaped foodstuff products are reduced. The conveyor machine with its conveyor device which is used for transporting away the shaped foodstuff products produced can remain within the production line. The conveyor machine has coupling means adapted to reversibly couple and uncouple the conveyor module with preferably the machine frame to and from the conveyor machine for conveying the foodstuff products. The coupling means used thus permit the conveyor machine according to the invention to be connected to a shaping module in the production line as often as may be desired, and to be separated again therefrom. The coupling means provides for at least a fixed orientation and/or arresting of conveyor machine and shaping module relative to each other. Preferably, at its housing side facing in opposite relationship to the conveyor direction of the production line the conveyor machine has on the machine frame one or more coupling means for reversibly coupling and uncoupling with the shaping module which is disposed upstream in the conveyor direction.

In accordance with a preferred development of the invention there are provided one or more coupling means for mechanically connecting machines which can be coupled together. A preferably rigid connection is achieved between the shaping module and the conveyor machine by way of the coupling means for producing the mechanical connection, in particular after the mechanical connection has been made. A relative movement of the machines which can be coupled together is avoided after coupling or after the mechanical connection has been made. The coupling means according to the invention permit connection and uncoupling of the machine and the module to and from each other, as often as may be desired.

An optional configuration of the conveyor machine according to the invention provides one or more coupling means for making an electrical and/or fluid-conducting connection between the machines which can be coupled together. Preferably a functional connection is made between the conveyor machine and the shaping module by way of the coupling means according to the invention. Preferably an electrical and/or hydraulic connection is made by way of the coupling means, whereby open-loop and closed-loop control devices on the machine or the module, which is also referred to as a machine, are controlled by signals or data which are output by the other machine. The functional connection between the machines which can be coupled together makes it possible to achieve mutually matched cyclic control of the machines which can be coupled together and which are arranged in succession in the conveyor direction of the foodstuff product. Electrical control signals or data are transmitted by means of the electrical connection. Actuation or control of different machine parts like for example adjusting drives or clamping devices is effected by way of the hydraulic connection, for example by means of compressed air or hydraulic fluid.

Preferably the coupling means has a receiving portion which is of a design configuration corresponding to a counterpart portion of a coupling means of the shaping module, which counterpart portion can be received in or at the receiving portion. The provision of a receiving portion on the conveyor machine, into which preferably a corresponding counterpart portion of a coupling means of the shaping module is pushed or inserted at least provides that two machines which can be coupled together (conveyor machine and shaping module) are oriented at least transversely relative to the direction of the insertion of the cooperating coupling means.

An alternative configuration of the conveyor machine according to the invention provides that the coupling means is in the form of a counterpart portion which can be received in or on a receiving portion. The counterpart portion accordingly corresponds to the receiving portion of a coupling means of the shaping module. The connection of the coupling means of both machines is achieved in particular by a relative movement of at least one of the machines which can be coupled together. In that case the spacing between the machines that can be coupled together is reduced or the conveyor machine and the shaping module are oriented relative to each other, in such a way that the receiving portion and the counterpart portion are in mutual engagement. The receiving portion and the counterpart portion are arranged at the machines which can be connected together, in such a way that the receiving portion and the counterpart portion have an insertion direction preferably extending substantially parallel to the conveyor direction of the production line.

Preferably the receiving portion is in the form of a holding portion having a plurality of preferably horizontally extending holding struts or in the form of a sleeve body. That provides a structurally simple configuration for the coupling means which can be brought into mutual engagement for mechanically connecting the machines. Preferably, use is made of a receiving portion which is in the form of a holding portion and which preferably has a plurality of approximately horizontally extending holding struts preferably arranged in mutually spaced superposed relationship in a vertical plane. The holding portion is preferably adapted to support and receive the shaping module by way of its holding struts, with the shaping module being suspended in the holding portion. The coupling portion of the shaping module has receiving slots corresponding to the holding struts, with the receiving slots being suspended on the holding struts. Alternatively, a sleeve body of a rectangular or cylindrical internal cross-section is used, into which a bar can be inserted as the counterpart portion. The external cross-section of the bar is preferably of a configuration corresponding to the inside cross-section of the receiving portion, whereby a positively locking connection is guaranteed between the coupling means of the two machines, that are to be brought into mutual contact, in particular transversely relative to the insertion direction. Preferably the bar is of an external cross-section which preferably increases from its free end in the direction of the opposite end.

In a further preferred configuration of the machine according to the invention associated with the coupling means is an arresting device adapted to arrest the coupling means of the shaping module relative to the coupling means. That provides that, after the two machines have been mechanically connected, the coupling means and thus preferably the shaping module and the conveyor machine are fixedly connected together. The shaping module and the conveyor machine can no longer be moved relative to each other after activation of the arresting device. A relative movement, in particular a displacement movement, of in particular the shaping module, by means of rollers preferably arranged on the machine frame, is advantageously counteracted in that way. The arresting device has a measuring and/or detection device adapted to ascertain whether the coupling mean of the conveyor machine and the shaping module are completely in engagement with each other and are therefore in the coupling position. For that purpose the measuring and/or detection device has one or more sensors like for example inductive initiators. The measuring and/or detection device is also adapted to output an activation signal to the arresting device for automatically arresting the coupling means, when the coupling means reach the coupling position.

Preferably the arresting device has at least one moveably mounted arresting element which can be moved into an arresting position in which the coupling means are arrested relative to each other and a release position for the coupling means. The moveably mounted arresting element also ensures a releasable connection between the coupling means of the machines and in addition reversible coupling and uncoupling as between the machines themselves. Preferably the arresting element is mounted moveably along an axis of movement preferably oriented perpendicularly or transversely relative to the insertion direction of the coupling means which for example is in the form of a bar.

A preferred configuration of the invention provides that the arresting element has a locking pin which in an arresting position can be brought into a positively locking connecting relationship with an opening on the coupling means of the shaping module. The locking pin adapted in the arresting position of the arresting device to engage into preferably an opening on the coupling means of the respective other machine ensures preferably play-free arresting of the two coupling means relative to each other. To make the positively locking connection between the locking pin and the opening of the coupling means which is preferably in the form of the bar the locking pin is preferably moved perpendicularly to the insertion direction of the bar into the coupling means in the form of the receiving portion.

In an alternative configuration of the machine according to the invention the arresting element has one or more clamping portions which can be brought into holding operative connecting relationship with the connecting means of the shaping module. Preferably a holding force is produced on the surface of the coupling means of the shaping module, that is preferably in the form of the counterpart portion, with the one or more clamping portions. The counterpart portion is preferably carried on the machine with the arresting means in a coupling means in the form of the receiving portion. With only one clamping portion used as the arresting element which acts at one side on surface regions of the coupling means to be arrested, regions of the coupling means of the conveyor machine form a support for the one moveable clamping portion of the arresting device. When two clamping portions are used they preferably act from mutually opposite sides on the outer surface of the coupling means of the respective other machine. With the holding force produced by the clamping portions, a frictional locking connection is preferably produced between the surfaces of the clamping portions, that can be brought into contact with each other, and the coupling means which can be brought into holding operative connecting relationship therewith. The frictional connection between the components is selected to be so high that a relative movement at machines which are coupled together is prevented.

A further development of the invention provides that the arresting element is arranged on an adjusting drive which is manually actuated or which is electrical or which is controlled by means of a fluid (hydraulically). The arresting element for arresting the coupling means of the conveyor machine and the shaping module are transferred from the release position into the arresting position by way of the adjusting drive which is preferably a manually actuated spindle drive, an electric cylinder or a pneumatic cylinder. To release the coupling means from each other the arresting element is moved back again from its arresting position into its release position by the adjusting drive. With the various alternative configurations of the adjusting drive the arresting element can be easily actuated in each case and a high force can be produced by the arresting element on the coupling means to be secured.

Preferably the receiving portion has one or more electric plug connectors and a plurality of fluid-conducting plug connectors for coupling to one or more electric plug connectors and a plurality of fluid-conducting plug connectors at a counterpart portion of the shaping module, which counterpart portion corresponds to the receiving portion. The electric plug connector which is preferably in the form of a multi-pole plug permits a current-carrying connection to be made between the machines which are to be coupled or connected together like for example a shaping module and a conveyor machine, which preferably respectively have machine frames which are separate from each other. In addition, by way of the electric plug connectors, wherein one plug connector is in the form of a plug on the one machine and the other plug connector is arranged as a plug receiving means on the other machine, it is further possible to provide for specifically targeted actuation or adaptation of possible drive, closed-loop or open-loop control devices which are matched to each other on the two machines (conveyor machine and shaping module). A fluid-tight connection for transmitting compressed air or fluids under pressure between the two machines which can be coupled together is effected by way of the multiplicity or plurality of the fluid-conducting plug connectors on the receiving portion and the counterpart portion corresponding to the receiving portion. The current-conducting or fluid-conducting connection between the respective plug connectors on the receiving portion and the counterpart portion is preferably implemented at the same time with the mechanical coupling of the machines to be connected together. The operation of securing the current-conducting and/or fluid-conducting connection between the plug connectors is effected by means of the coupling means for mechanically coupling the conveyor machine and the shaping module.

Alternatively, in accordance with a development of the invention, the conveyor machine according to the invention, in place of a receiving portion with one or more plug connectors for an electrical connection and a fluid-conducting connection, has a counterpart portion with one or more electric plug connectors and a plurality of fluid-conducting plug connectors for coupling to a corresponding receiving portion on the shaping module. The counterpart portion and the plurality of plug connectors on the counterpart portion for making the electrical and fluid connection are similar to a plug which is received in the receiving portion and in preferably the plug connectors on the receiving portion for making the electrical and fluid connections. The plug connectors for the electrical and fluid connection on the receiving portion are preferably in the form of plug receiving means.

In a preferred configuration of the conveyor machine according to the invention one or more rollers are arranged on the machine frame for displacement of the conveyor machine. The conveyor machine is preferably designed to be displaceable with the rolling elements or rollers on the conveyor machine. That provides that the conveyor machine which is preferably disposed downstream of the shaping module in the conveyor direction of the foodstuff products to be produced can be displaced during the operation of changing or replacing a shaping module in the production line. In that way the changing or replacing operation for the shaping module is further simplified. The reference to being disposed downstream of the shaping module means that the conveyor machine is arranged downstream of the shaping module in the conveyor direction of the pasty material, preferably immediately adjoining same.

Preferably the portioning unit is arranged on the machine frame moveably substantially transversely relative to the conveyor direction of the endless string and is adapted to be moved between a parking position and a working position. The portioning unit or parts thereof are preferably mounted or received pivotably moveably or slidingly moveably on the conveyor machine. The portioning unit can thus be reciprocated between a working position in which the portioning unit continuously subdivides an endless string produced by a shaping module and a parking position in which the portioning unit is parked or put into intermediate storage when not in use, in particular being slid or pivoted between those positions. Preferably the portioning unit is moved in a direction transversely relative to the conveyor direction of the endless string. For the purposes of orienting the portioning unit relative to the various shaping modules which can be coupled to the conveyor machine, the portioning unit is adapted to be displaced preferably in parallel relationship in the conveyor direction of the endless string produced and a conveyor device preferably arranged at the conveyor machine.

A preferred embodiment of the conveyor machine according to the invention provides that the conveyor device has one or more endlessly circulating conveyor elements. By means of the endlessly circulating conveyor elements like for example an endless conveyor belt, it is advantageously possible to ensure a continuous discharge movement of the products produced by the shaping module. The conveyor device preferably has one, two or more conveyor elements. With two or more conveyor elements, it is possible to achieve or implement changes in direction in the conveyor direction of the products to be discharged or also modifications to the spacing between the products discharged by way of the shaping module at predetermined spacings.

In a preferred development the conveyor device has two mutually superposed conveyor elements driven in opposite relationship. By means of the mutually superposed conveyor elements it is possible to provide for a controlled discharge movement of the products produced, in a simple fashion. The lower conveyor element on which the products produced rest is a discharge conveyor belt, above which a further conveyor element, preferably a smoothing belt, is disposed at a predetermined spacing. The discharge conveyor belt and the smoothing belt are connected to the machine frame of the conveyor machine. Both conveyor elements, the discharge conveyor belt and the smoothing belt, are driven in opposite relationship by way of preferably different drive means, whereby precise control of the conveyor speed of the products produced is possible. Preferably the conveyor elements driven in opposite relationship have an identical conveyor speed. Post-shaping of the products to be produced can be implemented by altering the conveyor speeds whereby a relative movement of the conveyor elements with respect to each other takes place.

Preferably the mutually superposed conveyor elements are variable in their spacing relative to each other. The height of the smoothing belt above the discharge conveyor belt is adjustable, wherein preferably the smoothing belt is arranged on adjusting means for height adjustment. The upper conveyor elements can provide for a pressing action in respect of the products produced which are of a ball-shaped configuration, the substantially circular disk pieces of the pasty foodstuff material or the string portions of the pasty material, against the discharge conveyor belt. In a preferred configuration both conveyor elements are adjustable in their inclination on the conveyor machine with respect to the horizontal by way of the adjusting means for height adjustment.

A further development of the invention concerns shaping modules for the production of shaped foodstuff products of pasty material, comprising a shaping device for shaping three-dimensional products from the foodstuff material, wherein coupling means for releasably connecting the module to a conveyor machine for conveying foodstuff products according to one of the above-described preferred embodiments are provided at the shaping module. By means of the coupling means for releasably coupling to a shaping module according to the invention, a connection can be made and released again as often as may be desired and thus simple interchange on a conveyor machine can be implemented. The conveyor machine according to the invention with its conveyor device for conveying the foodstuff products can thus advantageously remain within the production line during a product change and the interchange linked thereto of the shaping module.

A further aspect of the invention concerns a modular system for shaping and conveying foodstuff products of pasty material, wherein a conveyor machine for conveying foodstuff products of pasty material is provided, having a machine frame on which the conveyor device for conveying foodstuff products is arranged, and a plurality of different shaping modules for the production of shaped foodstuff products, wherein provided on the conveyor machine and on the shaping modules are mutually corresponding coupling means for releasably connecting the shaping modules to the conveyor machine.

The invention is based on the realization that, with the separate configuration of the shaping module and the conveyor machine in the form of separate modules, which can be fitted together, of a system for producing and processing foodstuff materials for a product change, it is only a change or replacement of the part or portion of the production line, that is crucial in regard to the configuration of the specific form of the product to be produced, that is implemented. A change or replacement of apparatus parts which are still required in the production line is thus avoided. A mechanical connection is made between both machines by way of the coupling means provided on the shaping module and the conveyor machine, such coupling means preferably being respectively arranged on the shaping module and on the machine frame of the conveyor machine. In addition, an electrical and/or fluid-conducting connection between the machines which can be coupled together can be made by means of the coupling means. In regard to advantageous configurations of the conveyor machine attention is directed to the above-described structures.

Preferably each of the shaping modules has at least a shaping device for shaping three-dimensional products consisting of the foodstuff material. The coupling means used for releasably connecting the shaping module to the conveyor machine are preferably disposed directly on the shaping device of a respective shaping module. Preferably such shaping modules designed in accordance with the invention in that way are in the form of suspension modules which do not themselves have any installation structures of their own for connection to the foundation surface. The shaping device is structurally carried by the machine frame of the conveyor machine, that stands on the foundation surface.

In an alternative configuration of the system according to the invention each of the shaping modules has a machine frame on which the shaping device for shaping three-dimensional products is arranged, and preferably one or more rollers on the machine frame for displacement of the shaping module. The shaping device of the shaping module is arranged on a separate machine frame, by way of which the transmission of force to the supporting foundation surface is ensured. Preferably rollers or rolling elements for displacement of the shaping module are arranged on the machine frame. Replacement of in particular the shaping module in the production line is further simplified by means of the rolling elements. The rollers or rolling elements are disposed at the underside and are preferably freely moveable respectively about an axis of rotation oriented perpendicularly to the horizontal.

Preferably the shaping device is adapted for shaping an endless string of pasty material, wherein the shaping device has a shaping portion for delivery of the endless string, with which a conveyor unit is preferably directly associated. In a preferred embodiment besides a shaping device for the production of shaped foodstuff products, here for shaping an endless string of pasty material, the shaping module according to the invention has a conveyor unit. The endless string produced is further transported with the conveyor unit after its discharge in a substantially unchanged orientation. The conveyor speed of the conveyor unit is preferably matched to the discharge speed of the shaping device, thereby ensuring the production of a continuous endless string.

In one embodiment provided for informational purposes, a portioning unit for subdividing the endless string into string portions is preferably associated with the end of the conveyor unit. The endless string is subdivided into string portions of preferably uniform length by means of the portioning unit. The separated string portions are then preferably discharged directly after subdivision thereof from the shaping module and are taken over by the conveyor device of the conveyor machine. The string portions taken over by the conveyor device are carried away for further processing, in particular to a subsequent packaging station. The above-described configuration of the shaping module according to the invention is adapted for producing ground meat portions. The shaping module is also referred to as a ground meat portioning module.

The portioning unit has a portioning knife which passes the conveyor path of the endless string at predetermined time intervals. Simple subdivision of the endless string produced is effected with the use or involvement of a portioning knife. The portioning knife is preferably rotatably carried at one end by way of a rotary bearing and with its free end spaced radially with respect to the rotary bearing is guided moveably along a knife guide. The axis of rotation of the rotary bearing for the portioning knife is preferably oriented substantially parallel to the conveyor direction of the conveyor unit of the shaping module. The portioning knife passes or moves through the conveyor path for the endless string substantially at a right angle.

Another preferred development of the machine according to the invention provides that the shaping portion of the shaping device is in the form of an apertured disk having a plurality of through openings. An endless string is produced from a plurality of individual endless strings by means of the apertured disk with its plurality of through openings for the pasty material, which are arranged on the apertured disk in a predetermined pattern. The through openings in the apertured disk are preferably arranged outside the centre thereof. The through openings form an arrangement on the apertured disk, which is preferably in the form of a rectangle.

In an alternative configuration of the shaping module provided for informational purposes, the shaping device has a conveyor passage for shaping an endless string of pasty material, wherein the conveyor passage has an outlet with which a portioning unit is associated. A single endless strand of pasty material is produced by means of the conveyor passage which is of a preferably circular cross-section of a diameter in the range of between about 5 and 20 cm. The endless string produced is subdivided by means of the portioning unit associated with the outlet of the conveyor passage. In that case preferably circular disks of predetermined thickness are produced, also referred to as a patty, wherein the disk body after being cut off the endless string is discharged from the outlet of the conveyor passage by the endless string which is following it on. The disk body which is discharged or delivered is taken over by the conveyor device of the downstream-connected conveyor machine. The outlet of the conveyor passage can preferably be positioned in the near region of the beginning or the receiving region of the conveyor device of the conveyor machine.

The portioning unit of this embodiment preferably has a portioning knife which passes the conveyor path of the conveyor passage at predetermined time intervals and is adapted to subdivide the endless string of the foodstuff material into string portions prior to issuing from the conveyor passage. The fact that the knife passes through or severs the endless string of foodstuff material before the string issues from the conveyor passage has the advantage that the severed string portion retains its original external shape almost unchanged. The disk bodies produced, also referred to as a patty, are thus of a substantially uniform circular cross-section. Preferably the portioning knife passes through or penetrates the endless string of the foodstuff material transversely relative to the conveyor direction of the foodstuff material in the conveyor passage. The thickness of the disk bodies produced is determined by the flow speed of the foodstuff material in the conveyor passage and the speed of rotation of the portioning knife and the number of its blades. The portioning knife preferably has two blades. Conveyance of the pasty material through the conveyor passage can be a continuous process or conveyance can be carried out in an intermittent sequence, in which case separation of the string portion from the endless string is effected between two conveyor movements.

Another alternative configuration of the shaping module provided for informational purposes, provides that the shaping device has a portioning unit for shaping products of a spherical shape. The portioning unit preferably has a plurality of product outlets which are arranged closely beside each other. Preferably a plurality of balls or ball portions are simultaneously produced from the foodstuff material with such a shaping device which is designed in accordance with the invention, also referred to as a ball shaper. The discharged balls are preferably arranged in a row in mutually adjoining relationship and touch each other or are arranged in closely adjoining relationship. The product outlets of the portioning unit of the shaping module according to the invention, after coupling or connection of the shaping module and the conveyor machine, are preferably disposed immediately in the proximity of the receiving region of the conveyor device of the conveyor machine which can be arranged downstream. The discharged ball-shaped products are preferably discharged or transferred directly to the conveyor device of the conveyor machine.

Preferably the portioning unit has a cutting device with preferably two actively moveable cutting and/or shaping plates. The two cutting and/or shaping plates which are actively moveable relative to each other can ensure that the balls to be shaped or produced from the pasty foodstuff material are of a preferably uniform configuration. Preferably both cutting and/or shaping plates are moved at the same time. In particular at the front and rear ends of the products to be produced, that results in an improved ball-shaped configuration there. Preferably both cutting plates are coupled to a common drive device whereby the drive travel of the drive device can be advantageously reduced.

In a development of the shaping module according to the invention the shaping device has a filling flow divider which is disposed upstream of the portioning unit in the conveyor path for the pasty material. The filling flow divider arranged upstream of the portioning unit in the conveyor direction provides for a uniform distribution of the pasty foodstuff material of an overall conveyor flow flowing in the conveyor passage, to a plurality of individual conveyor flows. The individual conveyor flows are respectively coupled to mutually separated regions of the portioning unit. The filling flow divider provides for improved mass or weight distribution of the pasty foodstuff material to be conveyed from the overall conveyor passage to the individual conveyor passages to the portioning unit. The balls or ball portions discharged from the outlets of the portioning unit are advantageously almost of an identical weight and an identical size. The filling flow divider is preferably similar to a vane pump having a rotor moving in a chamber, wherein the axis of rotation of the rotor is arranged in parallel displaced relationship with the central axis of the chamber and the rotor has adjustable vane elements.

A preferred configuration of the system according to the invention provides that the conveyor machine is disposed downstream in the conveyor direction of the pasty foodstuff material of the shaping module. The conveyor machine which is arranged downstream of the shaping module in the conveyor path of the pasty foodstuff material preferably receives the foodstuff products produced by means of the shaping module and transports them away for further processing. Preferably the conveyor device of the conveyor machine is arranged directly in the near region of the outlet or outlets of the shaping module so that the products produced are transferred to the conveyor machine from the shaping module directly without the interposition of further conveyor means.

In a preferred configuration of the system according to the invention for shaping and conveying foodstuff products there is provided a filling machine which can be arranged upstream of the shaping module in the conveyor path of the pasty foodstuff material. The filling machine preferably includes a filling hopper for introducing and receiving the pasty foodstuff material, like for example meat emulsion, and a conveyor pump for conveying the pasty foodstuff material in the conveyor direction through a conveyor conduit, a meat grinder being arranged in the conveyor conduit. The conveyor pump can also be connected in fluid-conducting relationship to a conveyor passage of the various shaping modules.

Preferably the shaping module is in accordance with one of the above-described preferred embodiments and the conveyor machine of the shaping and conveyor apparatus according to the invention is also in accordance with one of the above-described preferred embodiments.

### BRIEF DESCRIPTION OF THE DRAWINGS

The invention is described in greater detail hereinafter with reference to embodiments and with reference to the accompanying drawings in which:

FIG. 1 shows a perspective view of a first embodiment provided for informational purposes, of the system for shaping and conveying foodstuff products,

FIG. 2 shows a perspective view of a second embodiment provided for informational purposes, of the system according to the invention,

FIG. 3 shows a perspective view of a further embodiment provided for informational purposes, of the system according to the invention,

FIG. 4 shows a perspective view of the conveyor machine in FIG. 1,

FIG. 5 shows a perspective view of a first embodiment of a filling machine,

FIG. 6 shows a perspective view of a further embodiment of the filling machine,

FIGS. 7 to 12 show perspective views of various embodiments of coupling means for mechanically connecting a shaping module and a conveyor machine,

FIGS. 13 and 14 show perspective views of coupling means for making an electrical and/or fluid-conducting connection,

FIG. 15 shows a perspective view of a further embodiment provided for informational purposes, of a system for shaping and conveying foodstuff products,

FIG. 16 shows a perspective of an embodiment of the system according to the invention,

FIG. 17 shows a perspective of an embodiment of a system,

FIG. 18 shows a perspective view of a modular system provided for informational purposes, comprising a conveyor machine and a plurality of different shaping modules,

FIG. 19 shows a perspective view of the conveyor machine with its coupling means according to the embodiment as shown in FIG. 18, and

FIG. 20 shows a perspective view of a further embodiment of the modular system according to the invention for shaping and conveying foodstuff products.

### DETAILED DESCRIPTION

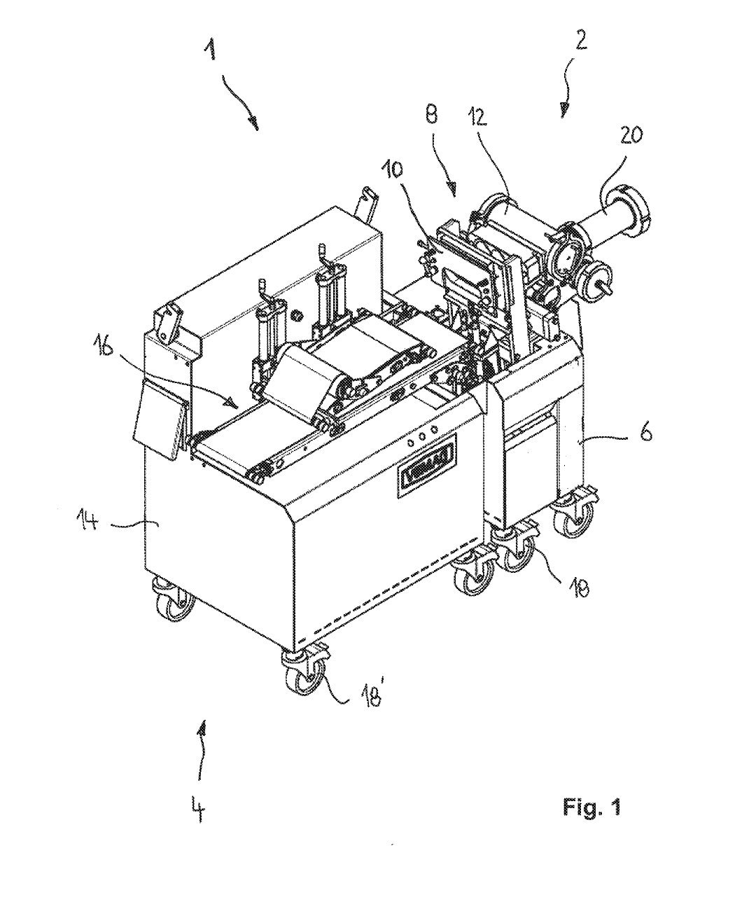

FIG. 1 shows a first configuration of a system for shaping and conveying foodstuff products of pasty material. The shaping and conveyor apparatus 1 has a shaping module 2 for the production of shaped foodstuff products consisting of the pasty material. A conveyor machine 4 is connected downstream of the shaping module 2 in the conveyor direction of the pasty foodstuff material.

The shaping module 2 has a machine frame 6, on which a shaping device 8 is arranged. The shaping device 8 has a portioning unit 10 adapted for shaping products shaped in a ball configuration. The shaping device 8 has a filling flow divider 12 arranged in the conveyor path of the pasty foodstuff material upstream of the portioning unit 10, that is to say the filling flow divider 12 is disposed before the portioning unit 10 in the conveyor direction of the pasty foodstuff material. The portioning unit 10 has a cutting device (not shown) with which the pasty foodstuff material divided into individual conveyor flows by the filling flow divider 12 is continuously shaped into the ball-shaped products.

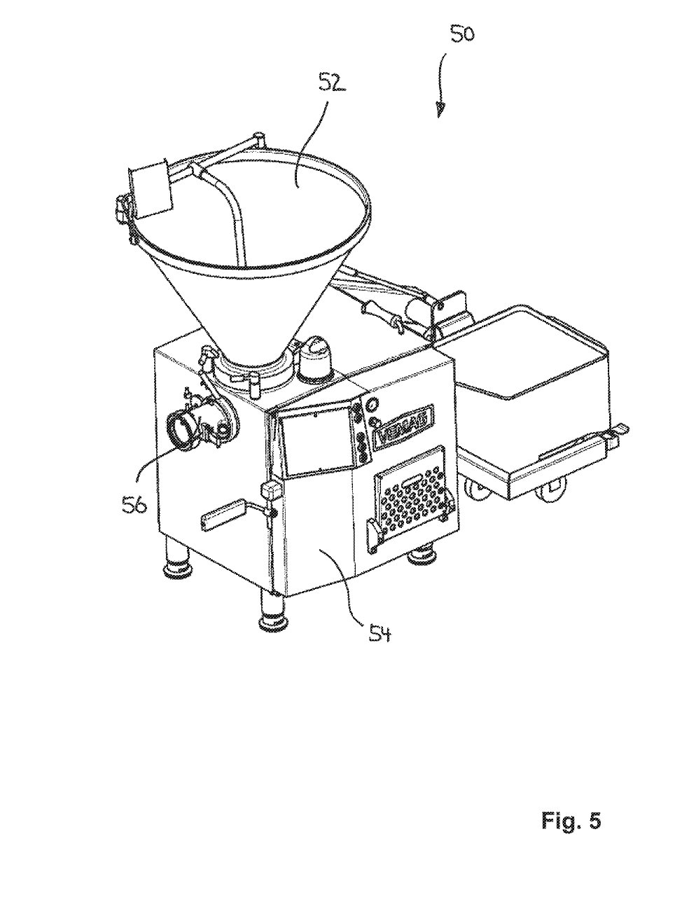

The products which are shaped and discharged by the shaping module 2 are taken over directly by the conveyor machine 4 which has a machine frame 14. Arranged on the machine frame 14 is a conveyor device 16 for conveying the foodstuff products discharged by the shaping module. A plurality of rollers 18, 18′ are arranged on the machine frame 6 of the shaping module 2 and the machine frame 14 of the conveyor machine 4, whereby the machines 2, 4 are displaceable. The displaceable machines 2, 4 which are provided separately from each other are both mechanically coupled together and also connected together in electrical and/or fluid-conducting relationship by way of coupling means described in greater detail hereinafter. The shaping module 2 also has a conveyor conduit 20, by way of which a filling machine 50 (see FIG. 5) disposed upstream of the shaping module 2 is connected to the shaping device 8.

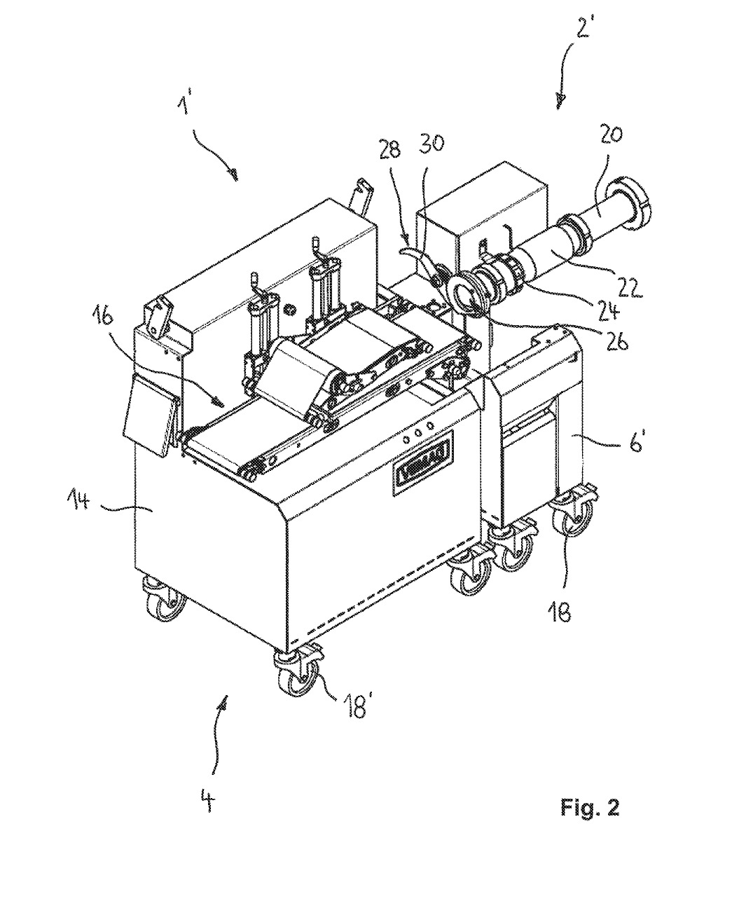

FIG. 2 shows a shaping and conveyor apparatus 1′ which includes a shaping module 2′ and a conveyor machine 4. The shaping module 2′ also has a machine frame 6′ with rollers 18, 18′ arranged thereon. Arranged on the machine frame 6′ is a shaping device 8′ having a conveyor passage arranged at the conveyor conduit 20, with a nozzle 24 for shaping an endless string of the pasty foodstuff material. Associated with the outlet 26 of the conveyor passage 22 is a portioning unit 28 with which an endless string conveyed in the conveyor passage 22 is subdivided into string portions of a circular cross-section. The portioning unit 28 has a portioning knife 30 with two blades, which passes through the conveyor path of the conveyor passage 22 at predetermined time intervals and subdivides the endless string of the foodstuff material into said string portions before it issues from the conveyor passage 22. The individual separated string portions are discharged directly on to a receiving region 43 of the conveyor device 16 of the downstream-arranged conveyor machine 4, by the pasty foodstuff material which flows on thereafter in the conveyor passage 22. The shaping module 2′ and the conveyor machine 4 are coupled or connected together by way of suitable coupling means mechanically and also electrically or hydraulically.

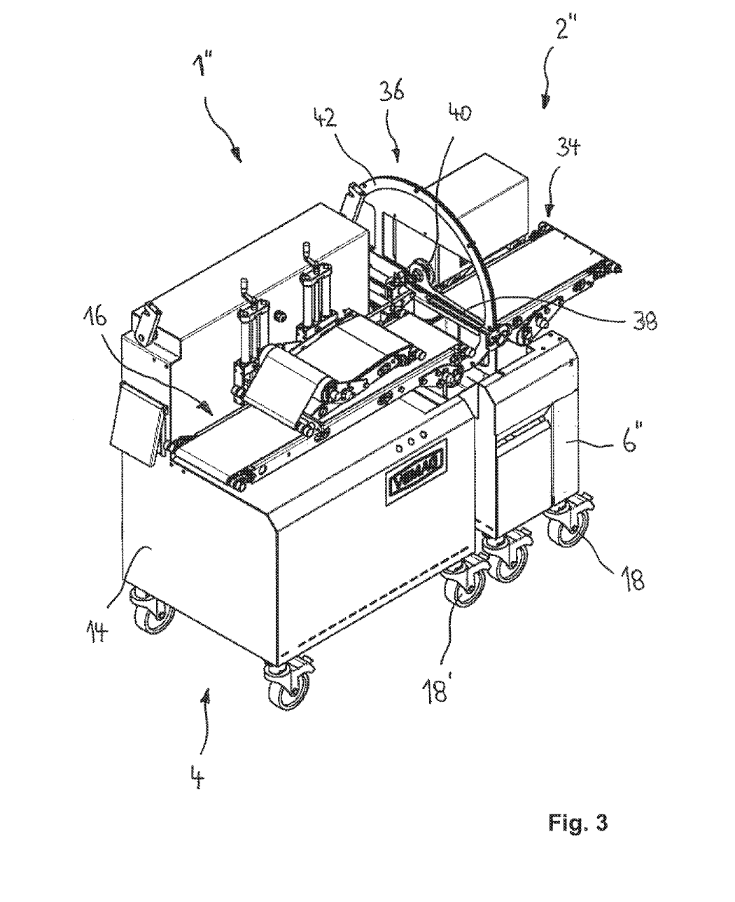

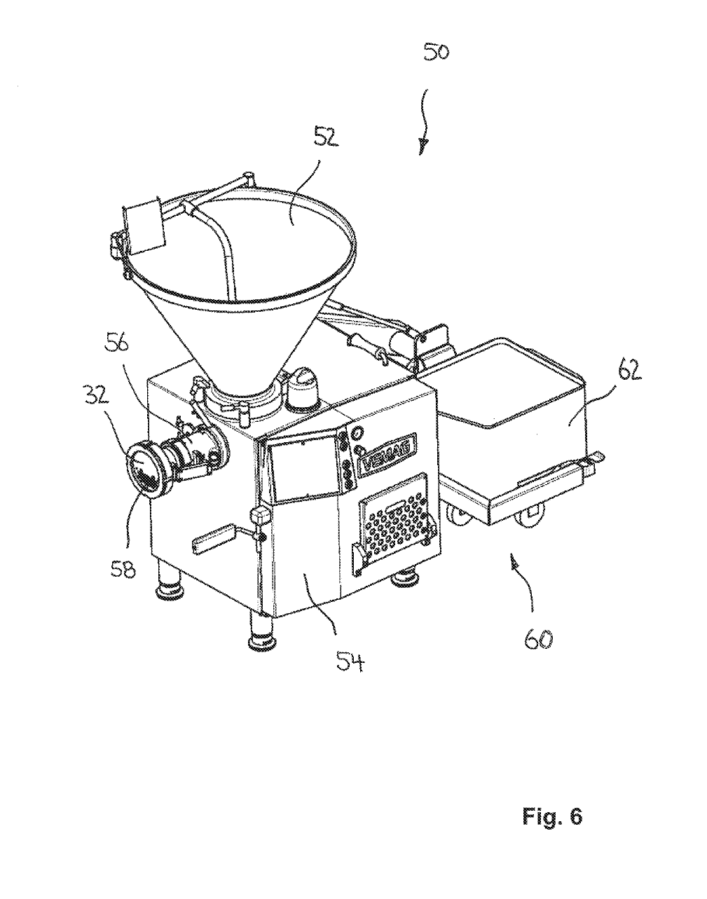

FIG. 3 shows a shaping and conveyor apparatus 1″ which includes a shaping module 2″ and the conveyor machine 4 disclosed in the previous embodiments. The conveyor machine 4 of the illustrated shaping and conveyor apparatuses 1 to 1″ (FIGS. 1 to 3) form in that case a so-called base module of the shaping and conveyor apparatus 1, 1′, 1″. The shaping module 2″ has a machine frame 6″ on which a shaping device 8″ is arranged. The shaping device 8″ is adapted for shaping an endless string of pasty foodstuff material, the shaping device 8″ having a shaping portion 32 (FIG. 6) for outputting the endless string. Directly associated with the shaping portion 32 is a conveyor unit 34 with which the endless string produced is conveyed over a predetermined travel path in an approximately horizontal direction. Associated with the end of the conveyor unit 34 is a portioning unit 36 for subdividing the endless string into string portions. The portioning unit 36 includes at least one portioning knife 38 which at one end is rotatably carried by way of a rotary bearing 40 and which with its radially outwardly directed end is guided in circulating relationship along a knife guide 42. The portioning knife 38 is driven continuously and is associated with the end of the conveyor unit 34 which has an endlessly circulating conveyor belt, in such a way that the portioning knife 38 passes through the conveyor path of the endless string at predetermined time intervals. In that respect the portioning knife 38 is adapted to subdivide the endless string produced into string portions of equal length. The shaping portion 32 of the shaping device 8″ (FIG. 6) is in the form of an apertured disk having a plurality of through openings.

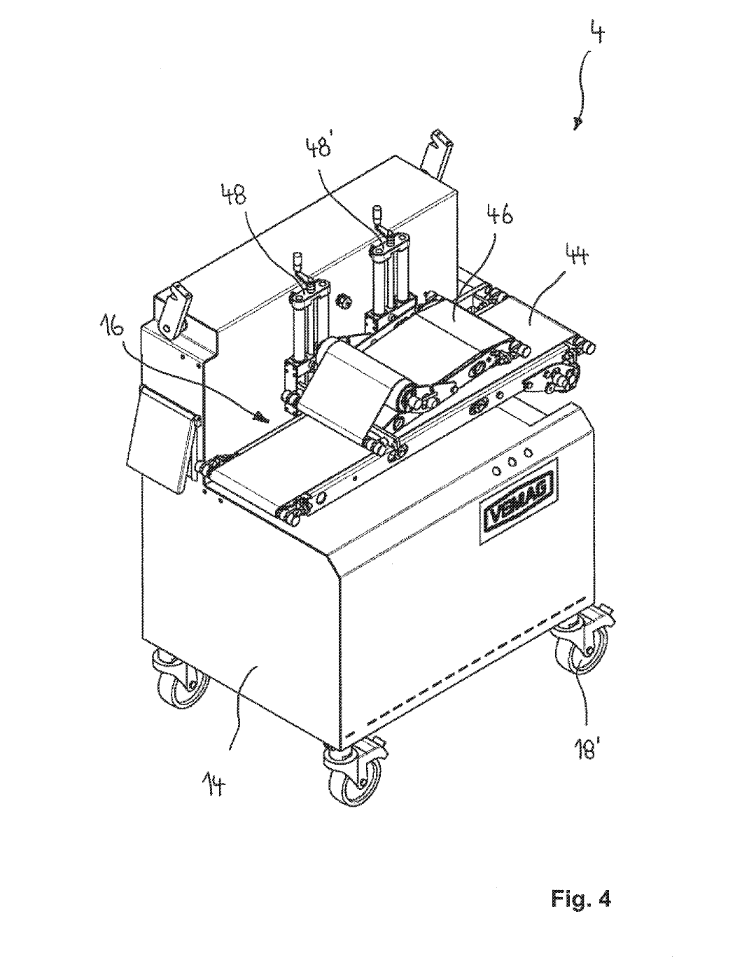

FIG. 4 shows the conveyor machine 4 as a base module of the shaping and conveyor apparatuses 1 to 1″. The various shaping modules 2 to 2′ shown in FIGS. 1 to 3 can be coupled as desired with the conveyor machine 4 as the base module. The conveyor machine 4 in turn has the machine frame 14 and the conveyor device 16 on the machine frame 14 for transporting away the three-dimensional foodstuff products produced by the shaping module 2′ from the foodstuff material. Arranged on the machine frame 14 of the conveyor machine 4 are rollers 18′, with which displacement ability of the conveyor machine 4 is also ensured.

The conveyor device 16 of the conveyor machine 4 has two endlessly circulating conveyor elements 44, 46. The conveyor elements 44, 46 are arranged one above the other and driven in opposite relationship. The conveyor element 44 is in the form of a discharge conveyor belt with which the foodstuff products consisting of the pasty foodstuff material, produced by the various shaping modules 2, 2′, 2″, are directly taken over. The upper conveyor element 46 is a smoothing belt which, depending on the nature and shape of the foodstuff products produced, is arranged at different spacings above the conveyor element 44. Height adjustment of the conveyor element 46 is effected by hand-actuated adjusting devices 48, 48′. The adjusting devices 48, 48′ are fixedly connected to the machine frame 14 of the conveyor machine 4, by way of which the inclination of both conveyor elements 44, 46 can also be altered relative to the horizontal plane. In an alternative configuration height adjustment of the conveyor belt 46 in the form of a smoothing belt is effected by a motorized adjusting drive.

FIG. 5 shows a filling machine 50 including a filling hopper 52 and a conveyor pump (not shown) which is arranged in the housing 54, by way of which the foodstuff introduced into the filling hopper 52 is comminuted and conveyed in the conveyor direction of a conveyor conduit 56. A meat grinder (not shown) is arranged within the conveyor conduit 56. The foodstuff material comminuted in the conveyor pump is ground with the meat grinder and a pasty foodstuff material of uniform consistency is thus produced. The conveyor conduit 20 shown in FIGS. 1 and 2 is coupled to the conveyor conduit 56.

The filling machine shown in FIG. 6 differs in relation to the previous embodiment by a shaping portion 32 which is mounted to the conduit 56 and which is in the form of an apertured disk having a plurality of through openings 58. The wall region provided with the through openings 58 is arranged eccentrically on the apertured disk in the illustrated embodiment. Arranged beside the filling machine 50 is a meat emulsion trolley 60 having a receiving container 62 for pieces of meat. The meat emulsion trolley 60 can be coupled to a lifting device (not shown), by which the receiving container 62 can be lifted and pivoted so that the pieces of meat in the receiving container 62 are transferred into the filling hopper 52 of the filling machine 50. After the meat emulsion trolley 60 has been emptied it is replaced or exchanged by another meat emulsion trolley which is fully filled with pieces of meat.

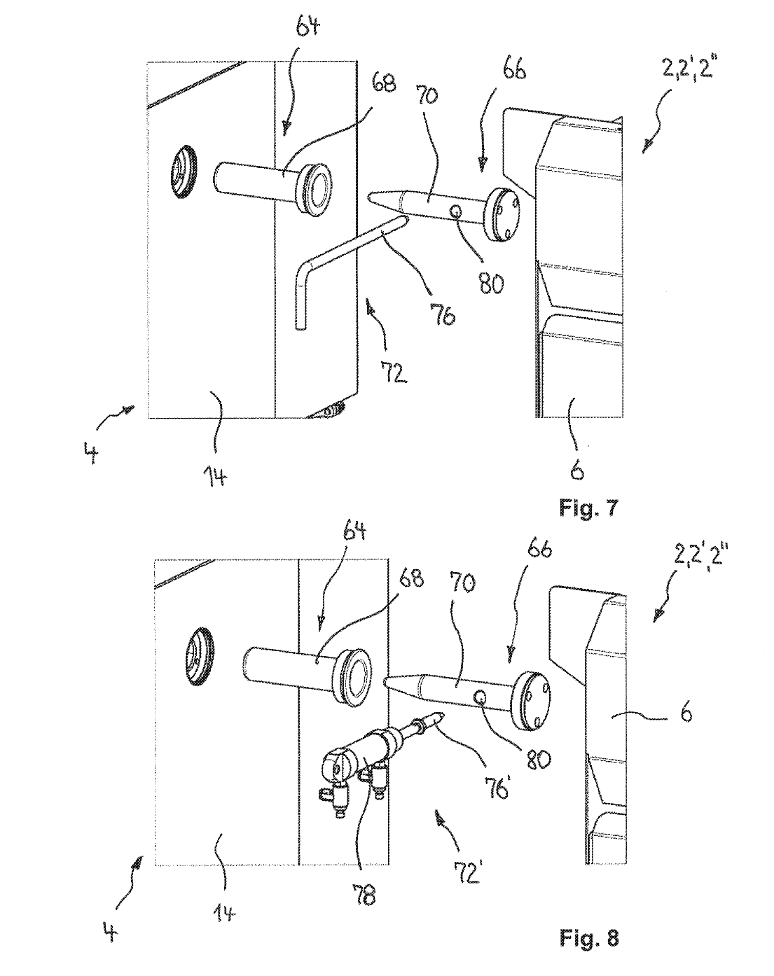

FIGS. 7 to 12 show embodiments of coupling means for mechanically connecting the shaping modules 2, 2′, 2″ to the conveyor machine 4. Arranged on the shaping module 2, 2′, 2″ and the conveyor machine 4 is a respective coupling means, the coupling means being of a mutually corresponding or complementary configuration. The corresponding configuration or the mutually matched design of the coupling means 64, 66 provides that, when connecting the coupling means, automatic orientation of the machines 2, 2′, 2″, 4 which are to be coupled together transversely relative to the conveyor direction of the pasty foodstuff material conveyed from the shaping module 2, 2′, 2″ in the direction of the conveyor machine 4 takes place. The shaping module and the conveyor machine are oriented in alignment in succession in the conveyor direction by way of the coupling means 64, 66. A receiving portion in the form of a sleeve body 68 is arranged as the coupling means 64 on the conveyor machine 4. As its coupling means 66 the shaping module 2, 2′, 2″ has a counterpart portion in the form of a bar 70, the bar 70 being matched with its outside diameter to the inside diameter of the sleeve body. The sleeve body 68 and the bar 70 of the two machines 2, 2′, 2″, 4 which can be coupled together are brought into contact with each other by the bar 70 being pushed into the sleeve body 68 or by the sleeve body 68 being fitted over the bar 70. The bar 70 is connected or coupled to the sleeve body 68 by a relative movement of the two machines 2, 2′, 2″, 4 which are to be coupled together. The direction of movement during the coupling operation and thus also the direction in which the bar 70 extends extend in the illustrated structures parallel to the conveyor direction of the pasty foodstuff material.

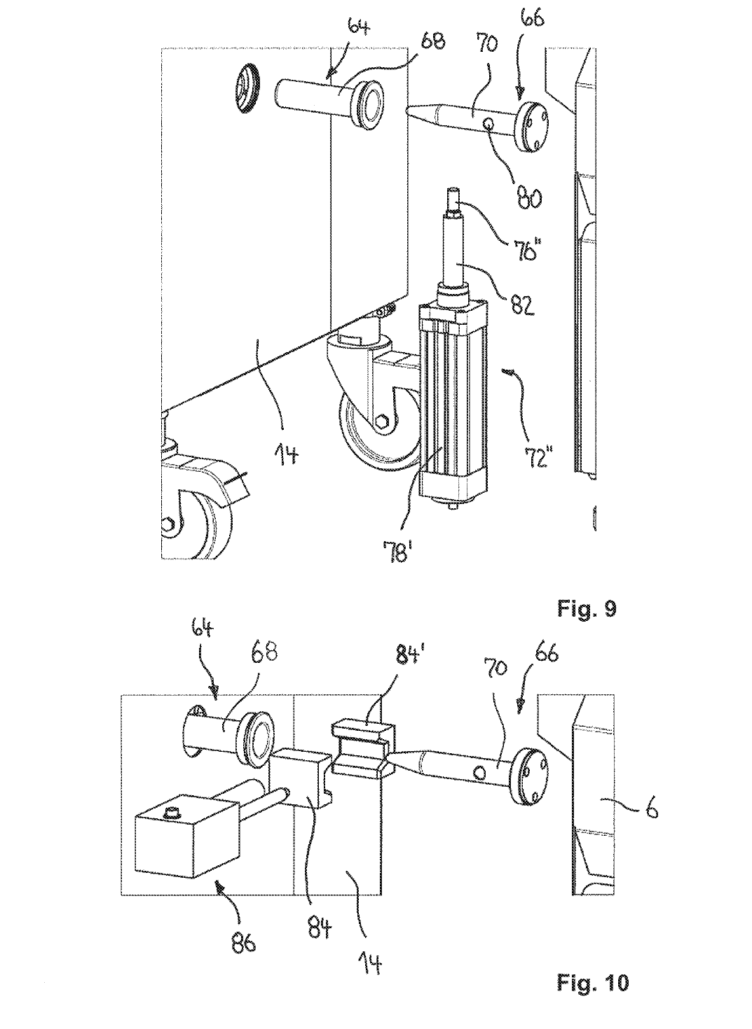

An arresting device 72, 72′, 72″, 74, 74′, 74″ is associated with the coupling means 64, 66 of the machines which can be coupled. The coupling means 64, 66 of the two machines are arrested relative to each other by way of the arresting devices, as long as the two coupling means are in engagement with each other and are in the coupling position. The arresting devices 72 to 72″ shown in FIGS. 7 to 9 are based on the fundamental function of making a positive locking connection between the arresting elements 76, 76′, 76″ and the coupling means 66. By virtue of the positively locking relationship between the arresting element 76 to 76″ and the coupling means 66 the coupling means 66 is fixed in the insertion direction relative to the coupling means 64 and thus at the same time the two machines 2, 2′, 2″, 4 are fixed together and the bar 70 is prevented from being pulled out of the sleeve body 68. The arresting element 76 in the FIG. 7 embodiment is in the form of a manually actuated locking pin member which engages into the opening 80 on the bar 70. The arresting element 76′ of the FIG. 8 arresting device 72 is a locking pin arranged on an adjusting drive 78 with a pneumatic cylinder, by way of which the arresting element 76′ is reciprocal between an arresting position and a release position for the coupling means 64, 66. In the arresting position the arresting element 76′ in the form of the locking pin engages in positively locking relationship into the opening 80 on the bar 70. The adjusting drive 78′ shown in FIG. 9 is an electric cylinder, on the displaceable piston 82 of which is arranged the arresting element 76″ in the form of the locking pin. In the arresting position the arresting element 76″ also engages substantially perpendicularly into the opening 80 on the coupling means 66 in the form of the bar 70.

FIGS. 9 to 12 show embodiments of arresting devices 74 to 74″ which instead of an arresting element corresponding in positively locking relationship to the coupling means 66, have two arresting elements 84, 84′ in the form of clamping jaws. A holding operative connection (used to hold these elements together) based on frictional engagement is produced between the clamping jaws and the bar 70 by means of the arresting elements 84, 84′. At least one of the arresting elements 84, 84′ is connected to an adjusting drive 86, 86′, 86″ to produce the frictionally locking connection between the bar and the clamping jaws.

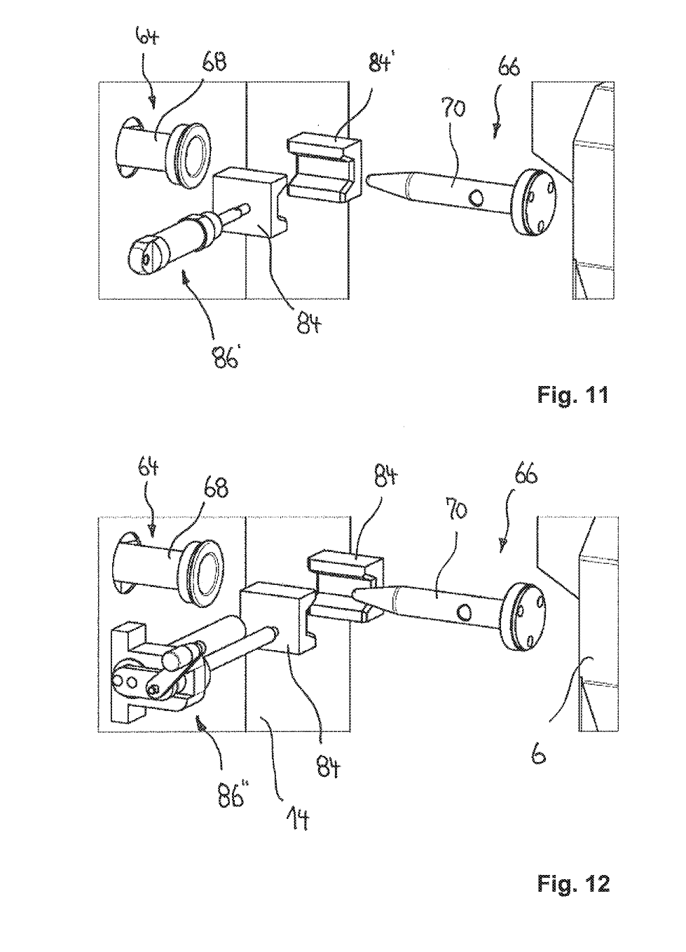

The adjusting drive 86 shown in FIG. 10 is an electric spindle drive with which the arresting element 84 is adjustable transversely relative to the direction of the insertion of the bar 70 into the sleeve body 68 and is pressed against the oppositely disposed arresting element 84′ in the form of clamping jaws. As can be seen from FIGS. 11 and 12 the adjusting drive 86′, 86″ used to produce the frictionally locking connection between the bar and the arresting elements 84, 84′ can be in the form of a pneumatic cylinder or a manually actuated spindle drive. All of FIGS. 7 to 12 are exploded views and show the arresting devices 72 to 74″ outside the housing of the machines 2, 2′, 2″, 4. Depending on which of the machines is equipped with the coupling means in the form of the sleeve body 68 and the coupling means 66 in the form of the bar 70, the arresting devices 72 to 74″ are disposed within the housing of the conveyor machine or shaping module having the sleeve body 68.

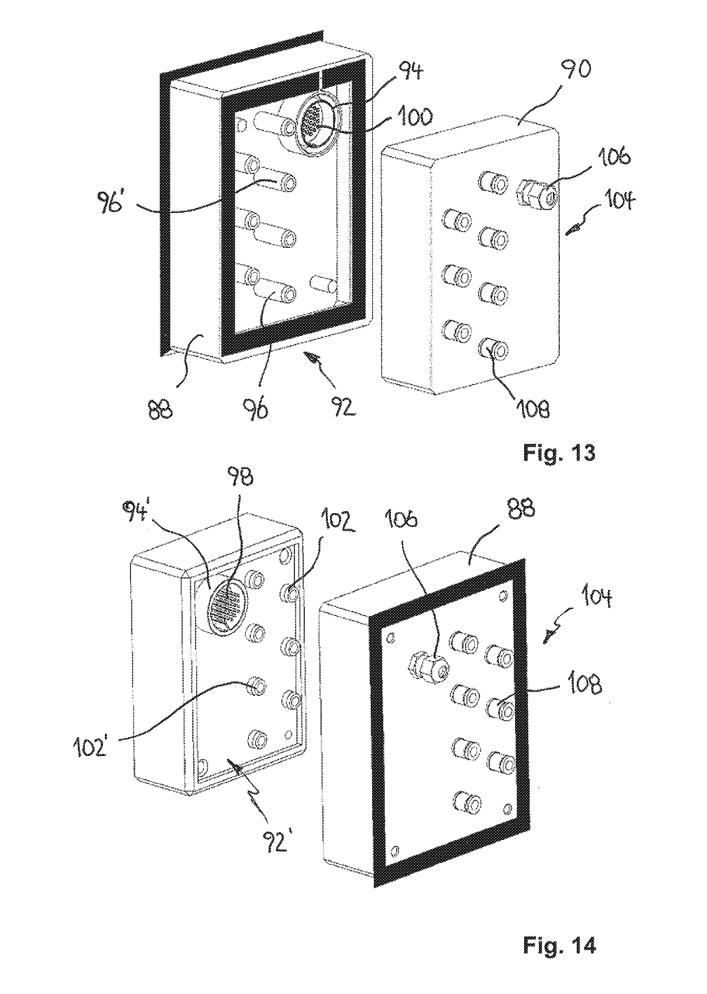

FIGS. 13 and 14 show coupling means 88, 90 for making electrical and/or fluid-conducting connections between the mutually machines 2, 2′, 2″, 4. The coupling means 88, 90 are respectively shown once from their front side and their rear side. The coupling means 88 in the present case is in the form of a receiving portion for the coupling means 90 which is in the form of a counterpart portion which may be inserted. On its contact side 92 towards the coupling means 90 the coupling means 88 performing the function of a receiving means has an electric plug connector 94 in the form of a multi-pole plug socket. In addition a plurality of fluid-conducting plug connectors 96, 96′ are arranged on the contact side 92 of the coupling means 88. On its contact side 92′ towards the coupling means in the form of the receiving portion the coupling means 90 has an electric plug connector 94′, the plug pins of which are inserted into the plug receiving means 100 of the electric plug connector 94 when joining the coupling means 88, 90. The plug connectors 102, 102′ for making a fluid-conducting connection on the contact side 92′ of the coupling means 90 form a sealing connection to the plug connectors 96, 96′ of the coupling means 88, when the coupling means 88, 90′ are joined. Arranged at the rear sides 104, 104′ of the coupling means 88, 90 are respective terminals 106, 108 for respective electrical current conductors which can be connected with the coupling means 88, 90 or fluid-conducting hose or pipe conduits. The same components are denoted by the same references.

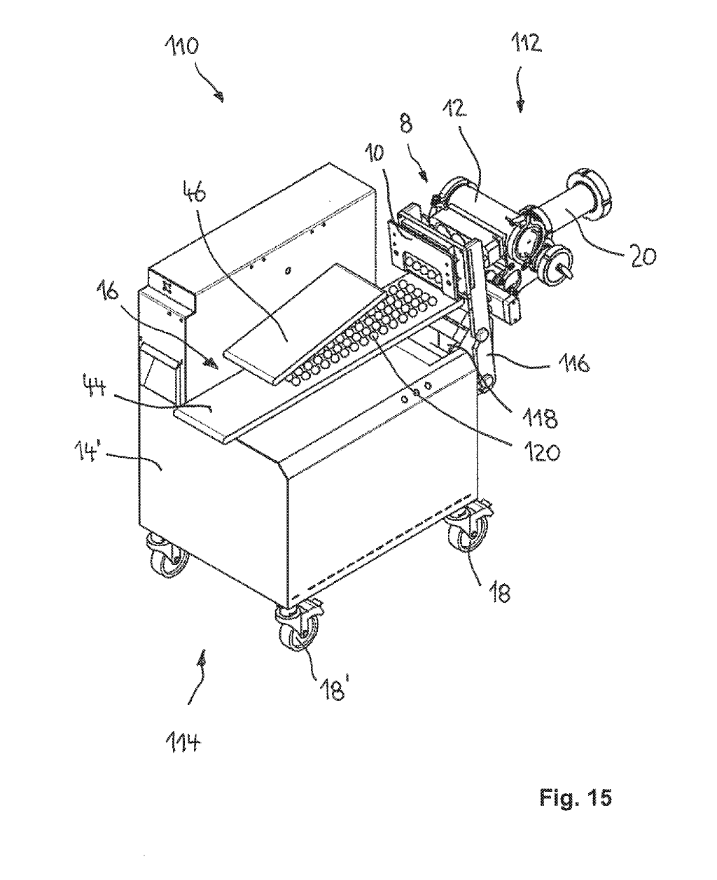

FIG. 15 shows a further embodiment of a system 110 for shaping and conveying foodstuff products of pasty material. The system 110 has a shaping module 112 for the production of shaped foodstuff products and a conveyor machine 114 disposed downstream of the shaping module 112 in the conveyor direction. In contrast to the previously illustrated embodiments the shaping module 112 has a shaping device 8 which is arranged directly on a holding portion 118 of the conveyor machine 114 by way of a support structure 116 on the portioning device, in particular being suspended therefrom. The holding portion 116 is arranged on the machine frame 14 of the shaping machine 114. The shaping module 112 is thus mounted to the shaping machine 114, in the form of the base module, of the illustrated system 110.

The shaping device 8 shown in FIG. 15 is adapted for shaping ball-shaped products and has a conveyor conduit 20 for conveying pasty material which is conveyed to the shaping device 8 for example by a filling machine 50 shown in FIG. 5. The pasty material conveyed in the conveyor conduit 20 is fed to a filling flow divider 12 with which the pasty material is uniformly subdivided into a plurality of conveyor flows (not shown). At the same time a plurality of ball-shaped products 120 are produced by means of the portioning unit 10 arranged downstream of the filling flow divider, and those products 120 after discharge from the portioning unit 10 are deposited in a row in mutually juxtaposed relationship on the conveyor element 44, in the form of a discharge conveyor belt, of the conveyor machine 114. The conveyor machine 114 has a machine frame 14′ on which a conveyor device 16 having two mutually superposed conveyor elements 44, 46 is arranged. The conveyor elements 44, 46 are variable in spacing relative to each other, that is to say are adjustable in their height relative to the machine frame 14′ on the shaping machine 114. The machine frame 14′ has a plurality of rollers 18, 18′ for displacement of the shaping machine 114 over the foundation surface.

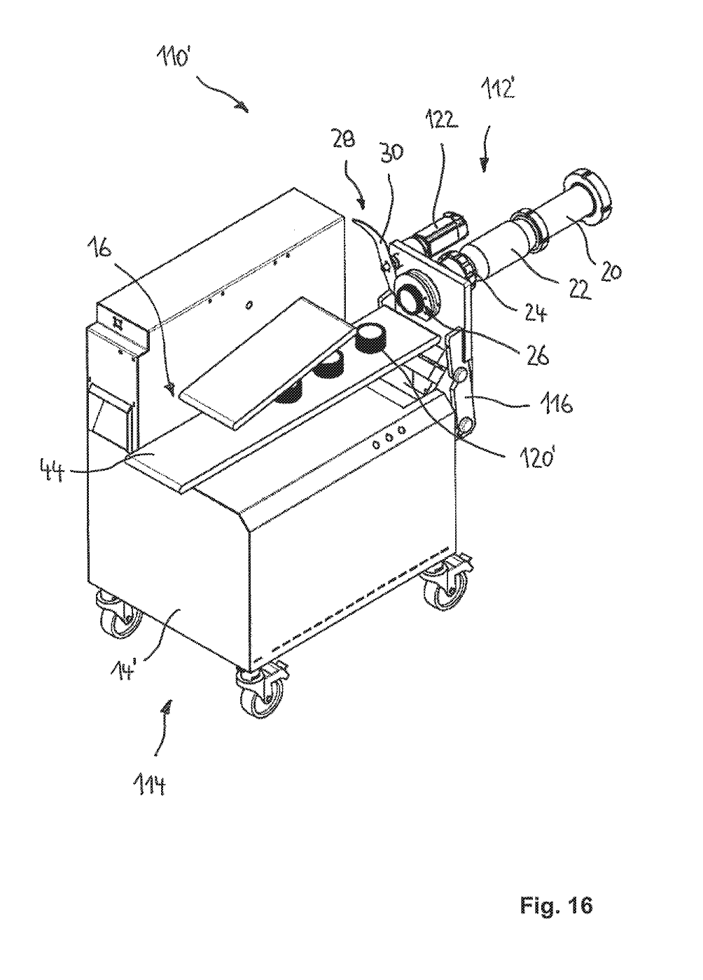

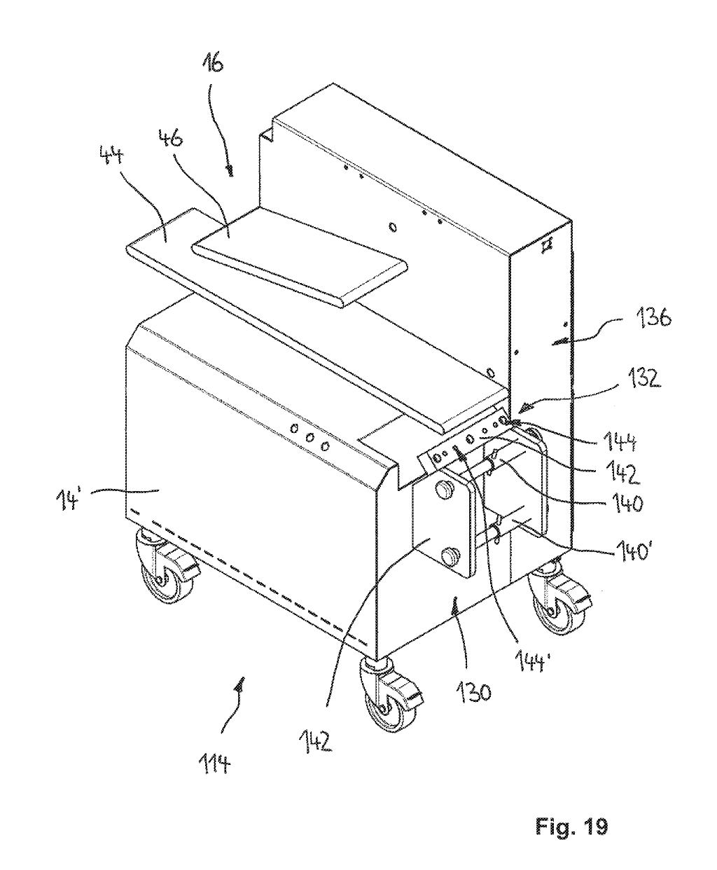

FIG. 16 shows a system 110′ for shaping and conveying foodstuff products comprising a shaping module 112′ and a shaping machine 114. The shaping module 112′ is adapted for shaping disk-shaped products 120′ of preferably circular cross-section. The shaping module 112′ in turn has a shaping device 8′ arranged directly on a holding portion 118 (FIG. 19) of the conveyor machine 114 by way of a support structure 116 arranged on the portioning device. The shaping module 112′ has a shaping device 8′ which has a conveyor conduit 20 for supplying it with pasty material and a conveyor passage 22 adjoining the conveyor conduit and having a nozzle 24 for shaping an endless string from the pasty foodstuff material. The conveyor conduit 20 is connected to a filling machine 50 (FIG. 5). The conveyor passage 22 has an outlet 26 with which a portioning unit 28 having a portioning knife 30 is associated. In relation to the conveyor direction of the pasty material in the conveyor passage 22 the portioning unit 28 is arranged upstream of the outlet 26. The portioning knife 30 driven by a motor 122 coupled thereto passes or moves through a slot in the conveyor passage 22 and through the endless string in a plane approximately perpendicular to the conveyor direction of the endless string whereby disk-shaped bodies or disk-shaped products 120′ of circular cross-section, also referred to as a patty, are continuously produced. The disk bodies produced are pushed out of the outlet 26 by the pasty material which follows same in the conveyor passage 22 and are transferred to a receiving region 43, associated with the outlet 26, of the conveyor element 44 of the conveyor device 16 of the shaping machine 114. In regard to preferred design configurations of the shaping machine 114 attention is directed to the foregoing description relating to the various embodiments of the shaping machine.

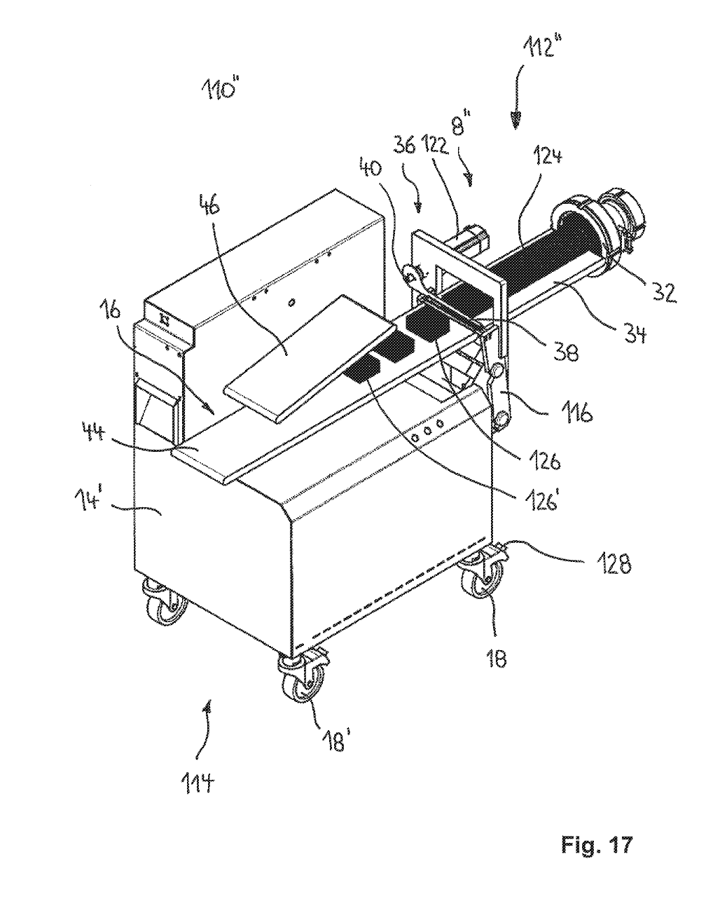

FIG. 17 shows a system 110″ for shaping and conveying foodstuff products of pasty material, having a shaping module 112″ and the shaping machine 114. Like the previous embodiments the shaping module 112″ has a shaping device 8″ which is also suspended from the holding portion 118 of the conveyor machine 114 by way of a support structure 116 arranged on the shaping device 8″. The shaping module 112″ does not have a separate machine frame for placement on the foundation surface. The portioning device is adapted for shaping an endless string 124 of pasty foodstuff material. The shaping device 8″ has a shaping portion 32 for discharge of the endless string 124, which is coupled in fluid-conducting relationship to a conduit 56 of a filling machine 50 (FIG. 5). Arranged directly downstream of the shaping portion 32 in the conveyor direction of the endless string to be produced is a conveyor unit 34 with which the endless string 124 produced is received and conveyed a predetermined distance. Arranged in a portion of the conveyor unit 34 is a portioning unit 36 for subdividing the endless string 124 into string portions 126, 126′. The portioning unit 36 includes a portioning knife 38 which passes through the conveyor path of the endless string 124 approximately transversely relative to the conveyor direction thereof. The portioning knife 38 is carried by way of a rotary bearing 40 and implements a rotary movement produced by a motor 122 transversely to the conveyor direction of the endless string 124. The string portions 126, 126′ produced are transferred to a conveyor device 16 connected downstream of the conveyor unit 34 of the conveyor module. The conveyor device 16 with its conveyor elements 44, 46 is arranged adjustably in height on the machine frame 14′. In the embodiment shown here rollers or rolling elements 18, 18′ are disposed at the underside of the machine frame 14, being respectively mounted freely rotatably about an axis of rotation oriented substantially perpendicularly to the foundation surface. The rollers or rolling elements 18, 18′ can arrested by securing brakes 128.

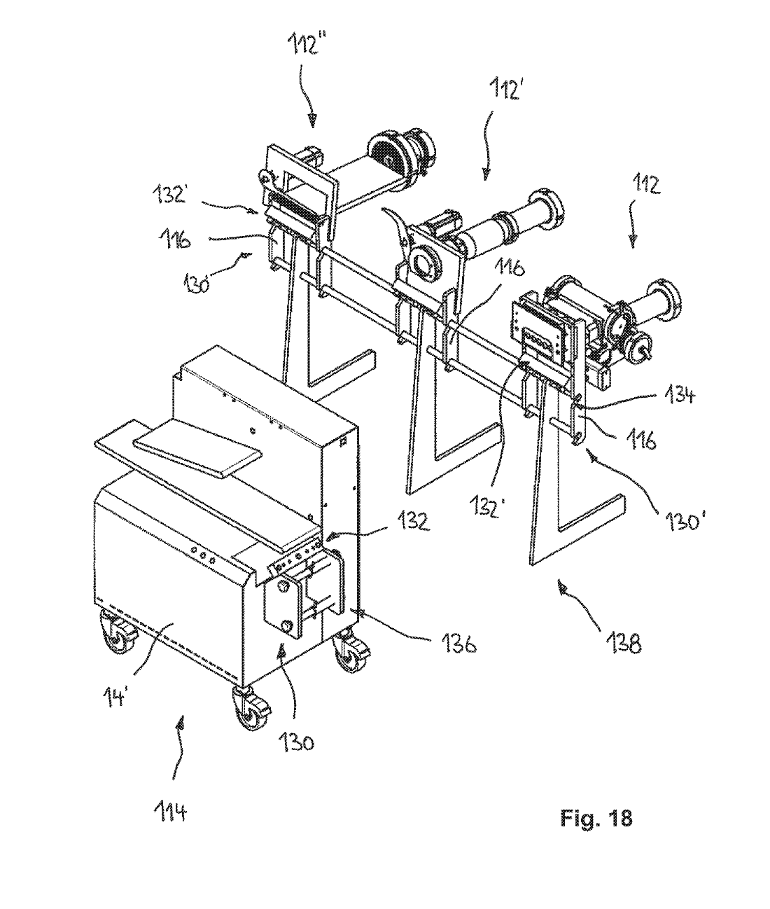

FIG. 18 shows a conveyor machine 114 according to the invention and shaping modules 112, 112′, 112″ respectively arranged beside it. The conveyor machine 114 and the various shaping modules 112, 112′, 112″ form a modular system according to the invention for shaping and conveying foodstuff products of pasty material. The conveyor machine 114 has coupling means 130, 132 for mechanically connecting and for making an electrical and/or hydraulic connection in relation to the shaping modules 112, 112′, 112″ which can be coupled to the conveyor machine 114 as the base module. Arranged at the shaping modules 112, 112′, 112″ are coupling means 130′, 132′ each of a respective configuration corresponding to the coupling means 130, 132 of the conveyor machine 114. The coupling means 130′ for releasably mechanically connecting the shaping modules are respectively provided on the support structure 116 in the form of receiving slots 134. The shaping modules 112, 112′, 112″ are respectively suspended from the holding portion 118 at the end 136 of the shaping module 114 by way of the receiving slots 134.

Shaping modules 112, 112′, 112″ which are not being used are stored at a receiving device 138 in the form of stands. Depending on what product is to be produced by means of the modular system according to the invention a corresponding shaping module 112, 112′, 112″ is coupled to the machine frame 14′ of the conveyor machine 114. The electrical and/or hydraulic connection between the shaping machine 114 and the shaping modules 112, 112′, 112″ which can be respectively coupled to the shaping machine are ensured by way of the coupling means 132, 132′.

FIG. 19 shows the conveyor machine 114 from its end 136, at which the coupling means 130, 132 for making a connection to a respective shaping module 112, 112′, 112″ are arranged or provided. The coupling means 130 for mechanical connection to one of the shaping modules 112, 112′, 112″ has two holding struts 140, 140′ which are arranged on the machine frame 14′ and which are oriented horizontally and which extend approximately parallel to each other. The holding struts are carried by way of two holding plates 142 which extend parallel to each other and project approximately perpendicularly on the machine frame 14′. The holding struts 140, 140′ are carried in mutually superposed relationship at different spacings relative to the end 136 of the conveyor machine on the holding plate 142. The coupling means 132 has a plug receiving means 142 with a plurality of plug connectors 144, 144′ for making a current-carrying and/or hydraulic connection to the shaping modules which can be coupled to the conveyor machine 114. Identical components are denoted by the same references.

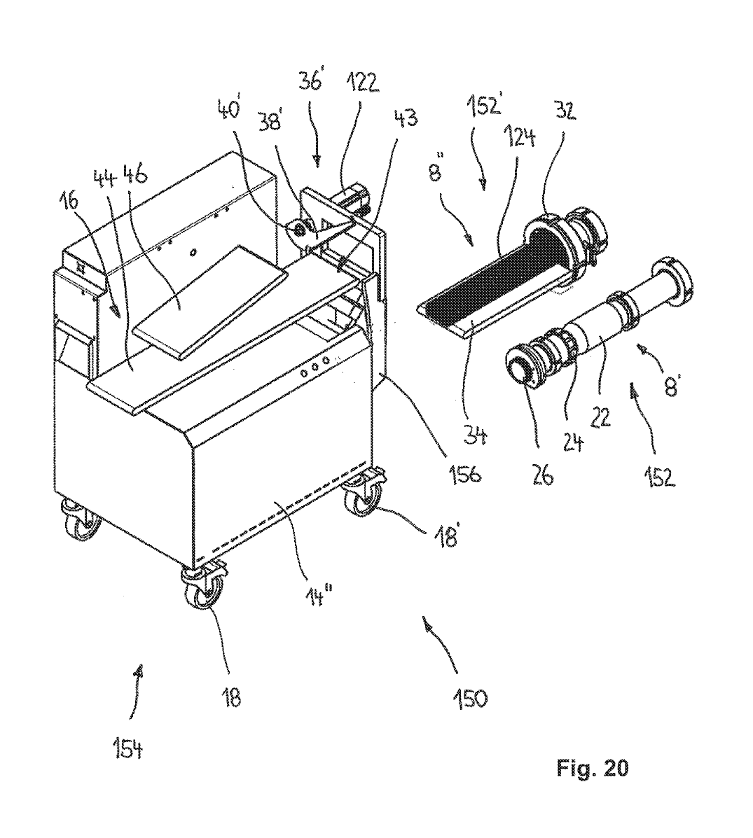

FIG. 20 shows a further embodiment of a modular system 150 according to the invention for shaping and conveying foodstuff products of pasty materials. The system 150 has shaping modules 152, 152′ and a conveyor machine 154 as the base module for the shaping modules 152, 152′ which can be coupled thereto. The conveyor machine 154 and the shaping modules 152, 152′ have first and second coupling means (similar to those described above) for making a releasable connection. Both a mechanical and also an electrical or hydraulic connection is made between the conveyor machine 154 and a respective one of the shaping modules 152, 152′ by means of the coupling means. The conveyor machine 154 has a machine frame 14″ and rolling elements or rollers 18, 18′ arranged thereon. As also described in relation to the previous systems 1, 110 according to the invention the conveyor machine 154 also includes a conveyor device 16 with conveyor elements 44, 46 arranged in spacing relative to each other and in height relative to the machine frame 14″. In addition fixedly connected to the machine frame 14″ is a portioning unit 36′ having a portioning knife 38′, the portioning unit being associated with the receiving region 43 of the conveyor element 44 in the form of a discharge conveyor belt. The portioning unit 36′ is thus arranged at the front end of the conveyor element 44 in relation to the conveyor direction of the conveyor device 16. The portioning unit 36′ is arranged on the machine frame 14″ by way of the illustrated support structure 156. In a design configuration the portioning unit 36 can be moved, in particular pivoted or slid, from its working position shown in FIG. 20 into a parking position. Movement into the parking position is implemented when the conveyor machine 154 is coupled to the shaping module 112 shown in FIG. 15 and having a shaping device 8 for shaping products of a ball-shaped configuration, also referred to as a ball shaper. In the working position shown here in FIG. 20 the knife 38′ passes through the conveyor path of the endless string 124 at predetermined time intervals. The endless string 124 is discharged continuously by way of the conveyor unit 34 from the shaping modules 152, 152′ which can be coupled to the conveyor machine 154, in the direction of the portioning unit 36′ of the conveyor machine 154, or are discharged at the outlet 26 of the conveyor passage 22. The portioning knife 38′ is carried by way of a rotary bearing 40′ with an axis of rotation oriented parallel to the conveyor direction of the endless string 124 and is driven by the motor 122 at preferably a continuous speed. The portioning knife in the present embodiment has a knife blade and is guided at the free end by way of a knife guide (not shown), preferably perpendicularly to the conveyor direction of the endless string 124. Alternatively the portioning knife 38′ has two knife blades which extend at both sides of the rotary bearing 40 and which are arranged displaced at 180° relative to each other. The shaping devices 8′, 8″ of the shaping modules 152, 152′ can each be coupled in hydraulic relationship to the filling machine 50 shown in FIG. 5.

### LIST OF REFERENCES

1, 1′, 1″ system
2, 2′, 2″ shaping module
4, 114 conveyor machine
6, 6′, 6″ machine frame
8, 8′, 8″ shaping device
10 portioning unit
12 filling flow divider
14, 14′, 14″ machine frame
16 conveyor device
18, 18′ rollers
20 conveyor conduit
22 conveyor passage
24 nozzle
26 outlet
28 portioning unit
30 portioning knife
32 shaping portion
34 conveyor unit
36 portioning unit
38 portioning knife
40 rotary bearing
42 knife guide
43 receiving region
44, 46 conveyor elements
48, 48′ adjusting means
50 filling machine
52 filling hopper
54 housing
56 conduit
58 through opening
60 meat emulsion trolley
62 receiving container
64, 66 coupling means
68 sleeve body
70 bar
72, 72′, 72″ arresting device
74, 74′, 74″ arresting device
76, 76′, 76″ arresting element
78, 78′ adjusting drive
80 opening
82 piston
84, 84′ arresting element
86, 86′, 86″ adjusting drive
88, 90 coupling means
92, 92′ contact side
94, 94′ electric plug connector
96, 96′ plug connector
98 plug pins
100 plug receiving means
102, 102′ plug connector
104, 104′ rear side
106, 108 terminals
110, 110′, 110″ system
112, 112′, 112″ shaping module
116 support structure
118 holding portion
120, 120′ product
122 motor
124 endless string
126, 126′ string portions
128 securing brake
130, 132 coupling means
130′, 132′ coupling means
134 receiving slot
136 end
138 receiving device
140, 140′ holding strut
142 plug receiving means
144, 144′ plug connector
150 system
152 shaping module
154 conveyor machine
156 support structure

What is claimed is:

1. A conveyor machine for conveying foodstuff products made of pasty material, the conveyor machine comprising:
a machine frame,
a conveyor device arranged at the machine frame for conveying the foodstuff products,
first coupling means provided at the conveyor machine for releasably connecting the conveyor machine to a shaping module for the production of shaped foodstuff products, and
a portioning unit arranged on the machine frame for subdividing an endless string shaped by the shaping module into string portions, the portioning unit including a portioning knife which in a working position of the portioning unit passes a conveyor path of the endless string at predetermined time intervals,
wherein the portioning knife is rotatably carried by a rotary bearing and is driven by a motor, wherein the portioning knife defines at least one of a single-blade or a multi-blade knife.

2. The conveyor machine according to claim 1, wherein some of the first coupling means are mechanically coupled to second coupling means of the shaping module, and some others of the first coupling means make at least one of an electrical and fluid-conducting connection to the shaping module.

3. (canceled)

4. The conveyor machine according to claim 1, wherein the first coupling means includes a receiving portion in the form of one of a sleeve body and a holding portion which has a plurality of horizontally extending holding struts, the receiving portion being designed so as to correspond to a counterpart portion of second coupling means of the shaping module, the counterpart portion being received in the receiving portion.

5. (canceled)

6. The conveyor machine according to claim 1, wherein associated with the first coupling means is an arresting device adapted to arrest second coupling means of the shaping module relative to the first coupling means.

7. The conveyor machine according to claim 6, wherein the arresting device includes at least one moveably mounted arresting element which can be moved into an arresting position in which the first and second coupling means are arrested relative to each other and which can be moved into a release position.

8. The conveyor machine according to claim 7, wherein the arresting element is in the form of at least one of the following:
a locking pin which in the arresting position can be brought into a positively locking connecting relationship with an opening located on the second coupling means, and
one or more clamping portions which can be brought into operative connecting relationship to hold the second coupling means.

9. The conveyor machine according to claim 8, wherein the arresting element is arranged on an adjusting drive which is actuated manually, electrically, or hydraulically.

10.-15. (canceled)

16. The conveyor machine according to claim 1, wherein the conveyor device includes two mutually superposed conveyor elements driven in opposite relationship, wherein the conveyor elements are variable in their spacing relative to each other.

17. (canceled)

18. A modular system for shaping and conveying foodstuff products made of pasty material, comprising:
the conveyor machine according to claim 1, and
a plurality of different shaping modules for the production of shaped foodstuff products,
wherein provided on the conveyor machine and the shaping modules are mutually corresponding first and second coupling means for releasably connecting the shaping modules to the conveyor machine.

19. The system according to claim 18, wherein each of the shaping modules includes at least one shaping device for shaping three-dimensional products from the foodstuff products.

20. The system according to claim 19, wherein each of the shaping modules includes:
a machine frame on which the at least one shaping device is arranged, and
one or more rollers arranged on the machine frame for displacement of the shaping module.

21.-28. (canceled)

29. The system according to claim 19, wherein the at least one shaping device includes a portioning unit and a filling flow divider which is disposed upstream of the portioning unit.

30. The system according to claim 18, wherein the conveyor machine is disposed downstream of the shaping module.

31. The system according to claim 30, further comprising:
a filling machine which is arranged upstream of the shaping module.

32. (canceled)
